(19) United States
(12) Patent Application Publication
(10) Pub. No.: US 2020/0210920 A1
(43) Pub. Date: Jul. 2, 2020

(54) Machine Learning System for Demand Forecasting With Improved Date Alignment

(71) Applicant: Legion Technologies, Inc., Redwood City, CA (US)

(72) Inventors: Thomas Joseph, Atherton, CA (US); Yahya Sowti Khiabani, Fremont, CA (US); Sanish Mondkar, San Francisco, CA (US); Gopal Sundaram, Saratoga, CA (US)

(21) Appl. No.: 16/238,459

(22) Filed: Jan. 2, 2019

(51) Int. Cl. G06Q 10/06; G06N 20/00

(52) U.S. Cl. CPC G06Q 10/06315; G06N 20/00

(57) ABSTRACT

Disclosed is a machine learning system with date alignment features for improved demand forecasting for products and/or services. The system includes an appliance for more accurately aligning days and weeks between years, including adapting to holidays and special days, in order to ascertain the date in a previous year that most closely aligns with the date in the future for which the forecast is sought. The corresponding day in one or more previous years can then be computed and demand data associated therewith can be retrieved from data storage to be used in forecasting demand on the forecast date. The most closely aligned day from a previous year can be selected such that the aligned day is positioned appropriately within the calendar week and year and the aligned day falls within a week that is positioned appropriately within the calendar month (i.e., first week, last week or middle-month weeks).

### CROSS REFERENCE TO RELATED PATENT APPLICATIONS

This patent application is related to co-pending U.S. patent application Ser. No. 16/210,865, entitled “Demand Forecasting Using Automatic Machine-Learning Model Selection,” filed on Dec. 5, 2018.

### BACKGROUND

### Technical Field

Embodiments described in this disclosure relate generally to an improved demand forecasting system based on machine learning techniques, and more particularly to a machine learning system for demand forecasting with an improved process for accurately aligning days and weeks of a calendar year with corresponding days and weeks in previous calendar years.

### Brief Description of the Related Art

Workforce management and planning are significant drivers of profitability. In response to the rising Gig-economy and its constantly evolving labor laws, organizations are starting to invest in strategies for demand forecasting and labor scheduling in ever increasing numbers. Demand forecasting helps predict how busy an organization will be at any future moment so that the information can be used for better workforce management. By forecasting labor based on historical demand, organizations can avoid understaffing peak periods and/or overstaffing slow ones.

Accurate demand forecasting is therefore critical for organizations to anticipate staffing requirements and identify the most qualified personnel, at the right time, and in the right location. Recent demand data (e.g., historical data over the past few weeks or so) and demand data from previous years can be used by managers when forecasting demand and building out work schedules prior to assigning shifts to employees. But many organizations are running into major difficulty in obtaining long-term, systematic and accurate forecasting using conventional techniques.

### SUMMARY

The innovative techniques described in this disclosure are directed to a machine learning system for forecasting demand for products, items and/or services. In one embodiment, the system includes an appliance for more accurately aligning days and weeks between years, including adapting to holidays and special days, in order to ascertain the date in a previous year that most closely aligns with the date in the future for which the forecast is sought (hereinafter “forecast day” or “forecast date”). For purposes of this disclosure, the day or date from a previous year that is determined to be the most closely aligned with the forecast date is referred to herein as the “corresponding” or “aligned” day or date for that year. At least certain of the embodiments are configured to compute the corresponding day in one or more previous years and to extract demand data associated therewith to be used for improved demand forecasting on the forecast date.

In a preferred embodiment the system may determine how to select the most closely aligned day from a previous year such that one or more of the following constraints can be satisfied: (a) the aligned date occurs on the same day of the week as the forecast date, (b) the aligned day is positioned appropriately within the calendar year; (c) the aligned day falls within a week that is positioned appropriately within the calendar month (i.e., first week, last week or middle-month weeks); and (d) if the forecast day is a holiday or special day, then the aligned day output by the system comprises that holiday or special day in the previous year(s), regardless of the day of the week upon which it falls.

The aspects, features, and advantages of the disclosed embodiments will become apparent to those of ordinary skill in the art from the following description of specific embodiments in conjunction with the accompanying figures.

### BRIEF DESCRIPTION OF THE DRAWINGS

FIG. 1 depicts a conceptual block diagram of an example embodiment of a machine learning system for demand forecasting with improved date alignment in accordance with the teachings of this disclosure.

FIG. 2 depicts a conceptual block diagram of an example embodiment of a machine learning system for demand forecasting with improved date alignment in accordance with the teachings of this disclosure.

FIG. 3A depicts a flow chart of an example embodiment of a process for aligning days and weeks between years for forecast days falling in the first or last week of the month in accordance with the teachings of this disclosure.

FIG. 3B depicts a flow chart of an example embodiment of a process for aligning days and weeks between years for forecast days falling on a holiday or special day in accordance with the teachings of this disclosure.

FIG. 3C depicts a flow chart of an example embodiment of a process for aligning days and weeks between years for normal forecast days corresponding with a date falling on a holiday or special day in a previous year in accordance with the teachings of this disclosure.

FIGS. 4-6 depict timing diagram showing examples of a date alignment process in accordance with the teachings of this disclosure.

FIG. 7 depicts an overview block diagram of an example data processing system upon which the embodiments described in this disclosure may be implemented.

### DETAILED DESCRIPTION

Throughout this description numerous details are set forth in order to provide a thorough understanding of the various embodiments of this disclosure, which are provided as illustrative examples so as to enable those of skill in the art to practice the embodiments. It will be apparent to those skilled in the art that the techniques described in this disclosure may be practiced without some of these specific details, or in other instances well-known structures and devices may be shown in block diagram form to avoid obscuring the principles and techniques described in this disclosure. The figures and examples provided in this disclosure are not intended to limit its scope to any single embodiment, as other embodiments are possible by way of interchange of some or all of the described or illustrated elements. Moreover, applicants do not intend for any term in the specification or claims to be ascribed an uncommon or special meaning unless such meaning is explicitly set forth herein.

Broadly speaking, when the system is forecasting demand for some item or service, it is attempting to predict the occurrence of something on a future date based on what the system has learned from historical demand data in previous years. In the present approach, a machine learning system can be used evaluate and determine how to select the most closely aligned day from a previous year to obtain the most relevant historical data for use in improved demand forecast modeling and analysis for the forecast date. In one aspect, a machine learning system for demand forecasting is provided. The machine learning system includes an improved appliance for more accurately aligning days and weeks between years—including adapting to holidays and special days—in order to ascertain the corresponding date from a previous year that most closely aligns with the forecast date for purposes of improving demand forecasting models and processes. For purposes of this disclosure, the term “appliance” refers to a combination of specially designed software application(s) and operating system to provide a particular computing resource. The hardware and software may be provided as an integrated or cloud-based solution for a particular application.

Once the most closely aligned day is determined, its associated historical data can be extracted from data storage (e.g., a database or other data storage device) and thereafter used as an input to one or more demand forecasting models on the machine learning system to improve the system's demand forecasting and modeling for items and/or services at various times throughout the forecast date. In some cases, knowing the historical demand on the aligned day alone can be the best piece of data for predicting what the demand will be on the forecast date.

In various embodiments, the most closely aligned day satisfies one or more of the following constraints: (a) the aligned date occurs on the same day of the week as the forecast date; (b) it is positioned appropriately within the calendar year; (c) it falls within a week that is positioned appropriately within the calendar month (i.e., first week, last week or middle-month weeks); (d) if it falls on a holiday or special day, then the aligned day output by the system comprises that holiday or special day in the previous year(s), regardless of the day of the week upon which it falls; and (e) if it falls on a normal day (e.g., in a mid-month week) but the corresponding day in a previous year falls on a holiday or special day, at least certain embodiments described herein can be adapted to take the average of the demand for the week before and after the aligned date and use the average demand as the demand value in the forecasting analysis for the forecast date.

Such solutions are, however, at times non-trivial. The start day of a year varies from year to year because years do not have a whole number of weeks, months do not have a fixed number of weeks or days, and the number of weeks and days within a particular month varies from year to year. Therefore implementing in computer hardware/software a machine learning system for performing demand forecasts based on historical data from aligned days in previous years can be quite complex.

### Example Systems

Provided below is a description of an example machine learning system for demand forecasting with improved date alignment according to the techniques set forth in this disclosure. Although certain elements may be depicted as separate components, in some instances one or more of the components may be combined into a single device or system. Likewise, although certain functionality may be described as being performed by a single element or component within a system, the functionality may in some instances be performed by multiple components or elements working together in a functionally coordinated manner. In addition, hardwired circuitry may be used independently or in combination with software instructions to implement these techniques.

Further, the features and aspects described herein are not limited to any specific combination of hardware or software. For example, the described functionality may be performed by custom hardware components containing hardwired logic for performing operations, by general-purpose computer hardware containing a memory having stored thereon programmed instructions for performing operations, or by any combination of computer hardware and programmed components. The features and aspects may also be practiced in distributed computing environments, such as in a private or public cloud-based network where operations may be performed by remote processing devices or systems that are in communication via one or more wired or wireless networks.

At a general level, machine learning involves algorithms and statistical models that computer systems can use to progressively improve performance of tasks over time without having to be programmed by a person to do so. Therefore machine learning systems improve as they “learn” from collecting additional input data and evaluating corresponding output data. Machine learning models can be developed based on processing “sample data”, referred to in the art as “training data”, using one or more machine learning algorithms. The training data may comprise a sufficient subset of a particular dataset in order to train one or more machine learning models. The “trained” machine learning model(s) can thereafter be used to make predictions or decisions about future events or data without being explicitly programmed to perform such tasks.

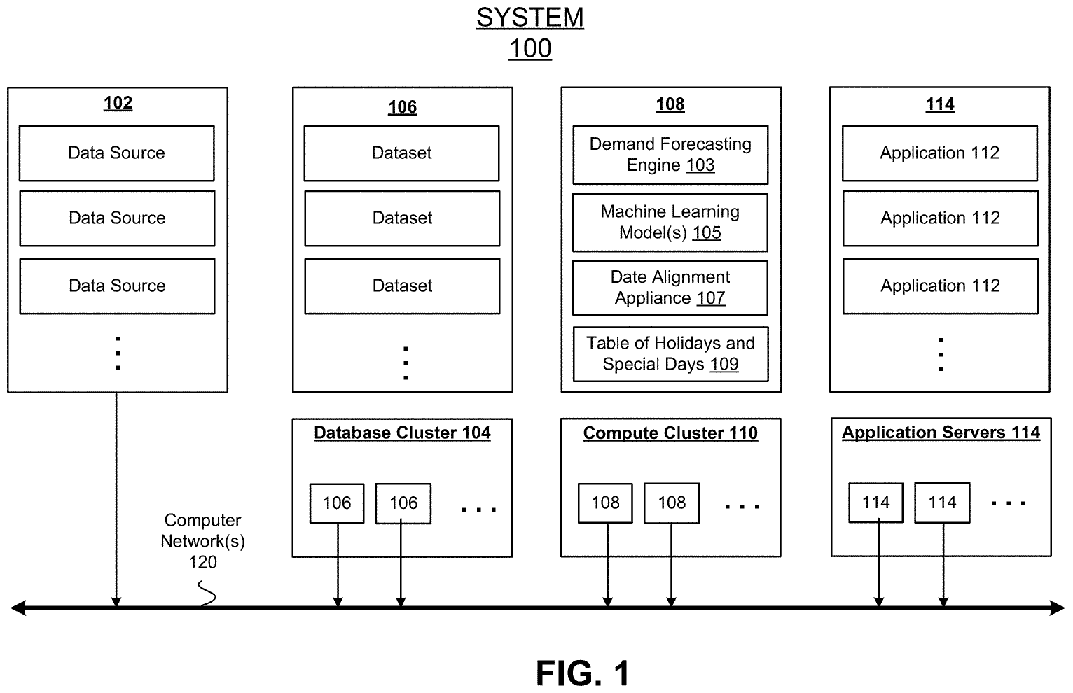

FIG. 1 depicts a conceptual block diagram of an example embodiment of a machine learning system for demand forecasting with improved date alignment in accordance with the teachings of this disclosure. As shown in the illustrated embodiment, system 100 includes a compute cluster 110 comprising one or multiple computer hardware servers 108 in communication with one or more data sources 102 over computer network 120, a database cluster 104 having one or more datasets stored thereon, and one or more application servers 114 for running software applications 112. Each computer hardware server 108 may include one or more processors and various levels of system memory and/or cache memory for performing operations for alignment of days and weeks between years and demand forecasting based on historical data associated with the aligned days.

New or updated demand data can be received by the computer servers 108 from one or multiple different data sources 102 via one or more computer networks or interconnections 120. Network(s) 120 can be implemented in any wired or wireless network or infrastructure, including in one or more private and/or public cloud-based networks. The data sources 102 may include point of sale (“POS”) systems that provide online payment processing and transaction data. In such embodiments, system 100 can be configured to integrate with various online POS systems (e.g., mobile payment processors such as Square, Inc. or Revel Systems, Inc.) to obtain demand data therefrom for more accurate and updated demand forecasting. System 100 can be configured to receive and store the data from data sources 102 into one or more datasets 106 in a data cluster 104. Each dataset 106 may contain data relating to different locations and/or categories of items for which demand forecasting is sought.

Based on the datasets 106, system 100 can thereafter compute demand forecasts for one or more forecast days for different goods, items, products or services, etc., at different times and dates, and for different locations. Demand drivers may include past sales, store traffic, seasonality, weather, nearby events, etc. For example, a certain bicycle shop may have three locations and the system can develop a machine learning model for each different type of product and/or service available at each of the different shop locations. This information can be used to determine the number and qualifications of personnel needed for each category of task to be accomplished for each shop location.

System 100 further includes compute cluster 110 comprising computer servers 108 connected via computer network 120. In one aspect, computer servers 108 may be configured as machine learning systems. In the illustrated embodiment, computer servers 108 comprise a demand forecasting engine 103, one or more machine learning models 105, a date alignment appliance 107, and a table of holidays and special days 109. In certain cases each of the machine learning models 105 may correspond with a different trained configuration of one or more machine learning algorithms. One or more software modules may be configured to run on the computer servers 108 to perform operations on the datasets 106 stored on (or otherwise accessible by) the database cluster 104. In one embodiment, the demand forecasts can be generated for 30-minute time increments for each item, product or service, or other such user-configurable level of granularity.

The machine learning model(s) 105 can be continually refined and/or retrained over time to improve the predictions and/or decisions as new data and/or data types is added to the system. The trained machine learning model(s) 105 may also be reevaluated from time to time to determine whether to retrain the model(s) based on changed conditions such as receiving new or different data or data types. Machine learning models may also be retrained when the accuracy of the model is determined to have degraded below a predetermined threshold value or as new data or data sources 102 become available on the network 120. In addition, in certain cases the input data may only be partially available or incomplete, and the machine learning techniques described in this disclosure can adapt to such situations.

System 100 may be scalable to concurrently perform demand forecast modeling and analysis operations for thousands of datasets in a time frame suitable for applications 112. In one aspect, computer servers 108, database cluster 104 and datasets 106 can be hosted in an environment allowing for computer servers 108 to be added and/or removed from the compute cluster 110 based on demand-such as in a commercial cloud-based network environment-allowing the system to scale in accordance with the size of the dataset(s) 106 or other factors monitored by the system 100.

System 100 further includes application servers 114 comprising one or more applications 112 connected via computer network 120. The one or more applications 112 running on application servers 114 can be configured to consume the selected machine learning models 105 via network 120. Employees and employers (e.g., administrators) may access applications 112 on the system using, for example mobile devices via network 120. Desktop or mainframe computers having hardwired connections, can also be used. Account information, such as login credentials, can be provided to set up accounts for users to access and configure the system. Employers can login and receive demand forecasts and can use that information to generate employee work schedules commensurate with the forecasted demand for the schedule period. Employees can enter their work availability and preferences via mobile devices interacting with applications 112 over network 120 and can receive optimized schedules based on their availability and preferences in accordance with the forecasted demand at the scheduled times.

The historical demand data supplied to the system from one or more different data sources 102 may comprise transaction data. As used herein the term “historical data” includes transaction data of any data type. In at least certain aspects, the demand data may be obtained from transaction data stored in one or more databases of online payment processors such as Square, Inc. and Revel Systems, Inc., which are configured to perform online payment processing and settlement operations for one or more transactions and to store the data generated from transactions into one or more databases accessible via one or more secure computer networks. Such demand data may include, for example, a description of the item or service sold, purchase price, and date of transaction, etc. According to the teachings of this disclosure, the transaction data from aligned dates in previous years can be used as an indicator/predictor of the demand for the particular item, product or service on the corresponding forecast date and used in the demand forecasting operations disclosed herein.

It should also be noted, however, that the teachings of this disclosure are not limited to online payment processors as certain embodiments may also be used with conventional payment processing networks such as those proprietary networks of Visa and MasterCard, which are also adapted to store transaction data in one or more databases that can be accessed over one or more secure financial networks.

In addition, the described embodiments are not intended to be limited to any particular demand data as any number of different types of data may be used to forecast demand for the goods, products, and/or services based on any number of user-configurable factors. Accordingly, other data and/or data types, in addition to transaction data, may be relevant as input(s) to the demand forecasting system. Store traffic data and duration of the store traffic, etc., that can be obtained from traffic counter systems, such as those provided by RetailNext® for example, may additionally be used as input(s) to the demand forecasting system.

Rapid developments in computer resources have provided businesses in the service industry with the potential to collect and maintain vast historical databases of transaction history. Conventional applications called Enterprise Resource Planning (“ERP”) applications have been developed over the years to generate such data. Examples of such conventional ERP packages include SAP, Baan, and PeopleSoft, among many others. Volumes of historical transaction data may therefore be available to those businesses that have archived data produced by various ERP applications. Transaction data that relates to purchase orders, service requests, and other activities is potentially available.

Moreover, system 100 may also be configured to process human resources data. Examples of such human resources data may include employee information (e.g., department, division, location, manager, etc.), change in job information (e.g., title, compensation grade, etc.), personal information (e.g., name, location, contact information, etc.), vacation, sick days, leaves of absence, short-term disability, long-term disability, suspensions, furloughs, termination, performance rating, training completion, career plans, etc. The innovative techniques described herein are applicable to environments in which there may be varying datasets by time, for example by time of day or day of week. The described techniques are applicable to varying workloads within an enterprise (or other entity) to be staffed with a variable number of personnel.

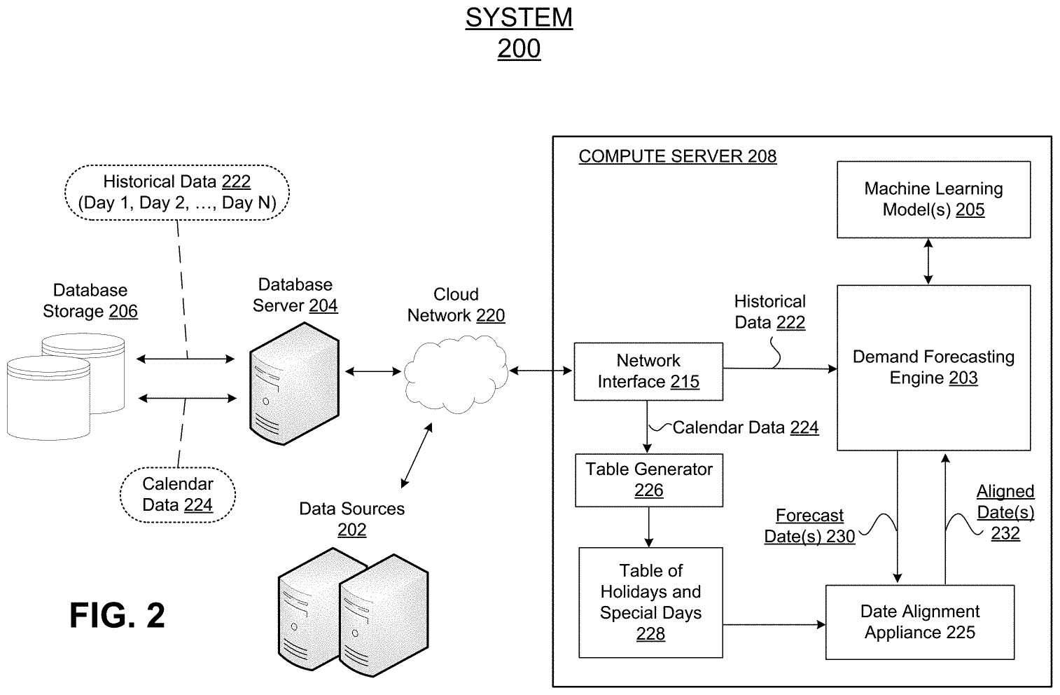

As discussed, the system for demand forecasting according to the teachings of this disclosure may be implemented as a machine learning system. FIG. 2 depicts a conceptual block diagram with further details of an example embodiment of a machine learning system for demand forecasting with improved date alignment. In the illustrated embodiment, system 200 includes a computer server 208 in communication with one or more database servers 204 over a cloud-based network 220. Network 220 can be any wired or wireless network connection or combination thereof. The computer server 208 can be configured to access data comprising datasets in the database storage 206 via database server 204 for storage and retrieval of historical data 222 and/or calendar data 224. In one embodiment, the historical data 222 may be arranged in the datasets 206 according to days, e.g., Day 1, Day 2 up to Day N. The calendar data may comprise basic calendar information, including holidays. The calendar data may also comprise customized information and special days configured for particular user contexts or user preferences.

Historical data 222 can be received from one or more data sources 202 and stored in database storage 206. Computer server 208 can retrieve the historical data 222 over cloud network 220 via database server 204 and network interface 215 and provide this information to the demand forecasting engine 203 for computing demand forecasts for one or more forecast days. The historical data 222 can be provided to the demand forecasting engine 203 for computing the demand forecasts for forecast days. The demand forecasting engine 203 can also use a dataset of historical data 222 or a subset of the dataset to train machine learning model(s) 205. The trained machine learning model(s) 205 can thereafter be used by the forecasting engine 203 along with the historical data 222 to predict demand for goods, items and/or services on the forecast date.

As shown in the illustrated embodiment, the input to the demand forecasting engine 203 further includes the actual historical demand data for one or more aligned date(s) in previous years that are determined to correspond with the forecast date. As shown, the demand forecasting engine 203 provides the forecast date(s) 230 (and times) to the date alignment appliance 225, and in response thereto, receives from the date alignment appliance 225 the aligned date(s) 232 for use in the demand forecasting analysis for the forecast date. The date alignment appliance 225 can be configured to perform the processing and operations for aligning the days and weeks between years in accordance with the techniques in this disclosure. The alignment appliance 225 can thereafter provide to the demand forecasting engine 203 the aligned date 232 from a previous year that corresponds most closely with the forecast date 230. This process can be repeated for each date to be forecasted and for each time new or revised historical data 222 is received from one or more data sources 202.

The date alignment appliance 225 communicates the aligned date 232 to the demand forecasting engine 203. The demand forecasting engine 203 can thereafter access historical data 222 corresponding with the aligned date 232. Specifically, the demand forecasting engine 203 can take as input for its demand forecasting modeling and analysis the date, timeslot, and a number value representing the demand forecast for that time on the aligned date and can output a number value representing the demand forecasted for each timeslot for that day, which in one embodiment can be determined in 30-minute timeslots.

It should also be noted that the historical data 222 can go back one or more years depending on how much historical data exists or is otherwise accessible to the system 200. Data typically does not align from year to year but can be aligned after seven (7) years of data. Many organizations, however, either do not have historical data going back that far. In other cases, the data going back that far may no longer be relevant or accurate due to changed circumstances. In general, the historical data 222 should not go back too far in time depending on how much circumstances have changed over time. Typically, useful historical data 222 may two to three years.

In the illustrated embodiment, computer server 208 further comprises a table generator 226 and a table of holidays and special days 228. The table generator 226 and table of holidays and special days 228 can be separate components as shown in FIG. 2 or can be incorporated together and/or incorporated into the demand forecasting engine 203. The table generator 226 can be configured to receive calendar data 224 from the cloud network 220 via network interface 215. In one embodiment, the calendar data 224 comprises basic calendar information, including holidays, as well as special days—e.g., the date of the Superbowl. TABLE 1 below shows an example table of holidays and TABLE 2 below shows an example table of special days. These tables can be implemented in system 200 as separate tables or they can be combined into one or more combined tables 228.

TABLE 1

| Holidays | 2018 | 2017 | 2016 |
|---|---|---|---|
| New Years' Day | January 1 | January 2 | January 1 |
| | | (observed) | |
| MLK Day | January 15 | January 16 | January 18 |
| Washington's Day | February 19 | February 20 | February 15 |
| Memorial Day | May 28 | May 29 | May 30 |
| Independence Day | July 4 | July 4 | July 4 |
| Labor Day | September 3 | September 4 | September 5 |
| Columbus Day | October 8 | October 9 | October 10 |
| Veterans Day | November 12 | November 10 | November 11 |
| Thanksgiving Day | November 22 | November 23 | November 24 |
| Christmas Day | December 25 | December 25 | December 25 |

TABLE 2

| Special Days | 2018 | 2017 | 2016 |
|---|---|---|---|
| Superbowl | Feb. 4, 2018 | Feb. 5, 2017 | Feb. 7, 2016 |

The table of holidays and special days 228 can thereafter be provided as an input to the date alignment appliance 225 for performing the aligned-date processing described in this disclosure. The date alignment appliance 225 is the unit that performs the date alignment functions and operations. It takes as inputs the dates to be forecasted and provides the corresponding aligned days in previous years as outputs to the demand forecasting engine 203. The special days calendar may contain a list of exceptions and other special days that may be configured by a particular user based on the user's specific requirements.

Generally the default case involves forecasting demand on a normal day (i.e., not a holiday or special day), that falls in a middle-month week, and that aligns with a normal day that falls in a middle-month week in a previous year. When the forecast day 230 is not a holiday or special day, then the system 200 performs normal-day processing. In normal-day processing, system 200 selects the historical demand data 222 associated with the aligned date 232 of the previous year and uses it as an input for the demand forecasting. In such cases, the system defaults to simply counting back to the same date 52 weeks ago and uses that date as the aligned date for the forecast. The historical data sample associated with the aligned date can then be input into the demand forecasting engine 203.

But other cases are not so trivial, such as instances where the default case does not apply, i.e., where there may be a holiday or special day, or the day falls in the first or last week of the month, etc., such that demand may significantly depart from the default case. As a first consideration, embodiments can take into account whether the forecast day falls on the first or last week of the month when aligning days and weeks between years. This can at times be important because it is not uncommon for demand for goods and/or services to increase or decrease significantly in the first and/or last week of a particular month as compared with middle-month weeks. As an example, a certain vendor may run a promotional campaign whereby customers are offered a discount on one purchase during their birthday month. Inevitably, some customers (many in fact) will show up to take advantage of such promotions in the last few days of the month. Accurate demand forecasting may therefore require consideration in certain cases as to whether the forecast date occurs in the first week or last week of a particular month. In other cases, the weeks in the middle of the month may be more important for a particular business or institution. If so, then the same forecasting techniques can be used to determine whether the forecast day falls on one of those middle-month weeks, or any combination of user-designated weeks within particular months.

In one aspect, the table of holidays and special days 228 can be thought of as an override calendar that can be used to align moving holidays with the exact holiday date from a previous year, by date. In other cases, the determination of whether the forecast day falls on a holiday or special day can be performed at the beginning of the process. In the context of holidays and special days, which in many cases vary within the month from one year to the next, the corresponding holiday or special day from a year ago may not fall on the same day of the month in the current calendar year. In other cases, a normal forecast day may have fallen on a holiday or special day in a previous year. Accurate demand forecasting therefore may require consideration in certain cases as to whether the forecast day falls on a holiday or special day and/or whether a normal forecast day falls on a holiday or special day in a previous year.

In a preferred embodiment, if the forecast day falls on a holiday or special day, then for accurate demand forecasting, the aligned day should be set to that particular holiday or special day in the previous year(s), regardless of what day or week of the month upon which it falls. And if a normal, mid-month forecast day falls on a holiday or special day in a previous year, then a modified demand forecast can be used instead. In one embodiment, the modified demand forecast may be obtained by taking the average of the demand from the week before and after the holiday or special day in the previous year and using that value as the demand for the forecast date. In another embodiment, the modified demand can be adapted to shift the aligned day by plus or minus one week in the previous year and using that demand data directly. In yet other embodiments, the modified demand can be obtained based on user configuration.

In other cases, system can be configured to determine whether the weeks before and after the holiday or special day in the previous year fall on the first or last week of the month, and if so, to select the day in the week from the previous year that has the greatest number of days in the same month as the forecast day in accordance with the techniques described above.

There may also at times be contradictory constraints or factors, or conflicting priorities, in determining the day in a previous year that most closely aligns with the forecast day. In such cases, there may be two days identified as the most closely aligned corresponding day, each based on a different constraint or factor. In those cases it may not be possible to pick one corresponding day. To remedy this situation, the system can be configured to prioritize some constraints over others and to make determinations as to what historical data is more closely aligned with the forecast day. For example, if the forecast day is Independence Day observed on July 4^{th} of a particular year, the system may initially identify the date as both a holiday as well as a day falling in the first week of the month of July. In such cases, a weighting scheme can be applied for determining which of the factors should have priority for consideration in computing the most closely aligned day from the previous year. In one embodiment, the system may apply a higher weighting factor for holidays and adapt accordingly. For example, the system may assign more weight to the fact that the day falls on Independence Day than to the fact that the day also happens to fall in the first week of July.

The demand forecasting system can also take into account any number of additional inputs that can be analyzed, processed, learned, modeled and stored, and thereafter utilized for improved demand forecasting in addition to, or in combination with, the date-aligned historical data generated using the described techniques. For example, recent historical data (e.g., for the last few weeks) can be used in addition to the date-aligned historical data from the disclosed embodiments to generate more accurate demand forecasts.

### Example Processes

The following figures depict flow charts illustrating various example embodiments of processes for improving alignment of days and weeks between years for enhanced demand forecasting in accordance with the teachings of this disclosure. It is noted that the processes described below are exemplary in nature and are provided for illustrative purposes, and not intended to limit the scope of this disclosure to any particular example embodiment. For instance, processes in accordance with some embodiments described in this disclosure may include or omit some or all of the operations described below or may include operations in a different order than described. The particular processes described are not intended to be limited to any particular set of operations exclusive of all other potentially intermediate operations. In addition, the operations may be embodied in computer-executable code, which may cause a general-purpose or special-purpose computer processor to perform operations for providing date alignment for demand forecasts. In other instances, these operations may be performed by specific hardware components or hardwired circuitry, or by any combination of programmed computer components and custom hardware circuitry.

One way to accomplish date alignment conventionally was by week number in the calendar year (i.e., Week 1, Week 2, . . . , Week 52) as the historical data for the demand forecast. But relying solely on week number for date alignment is insufficient for purposes of finding the most closely aligned day in a previous year because that date could be off by up to six (6) days depending on what day of the week January 1^{st} fell on that year.

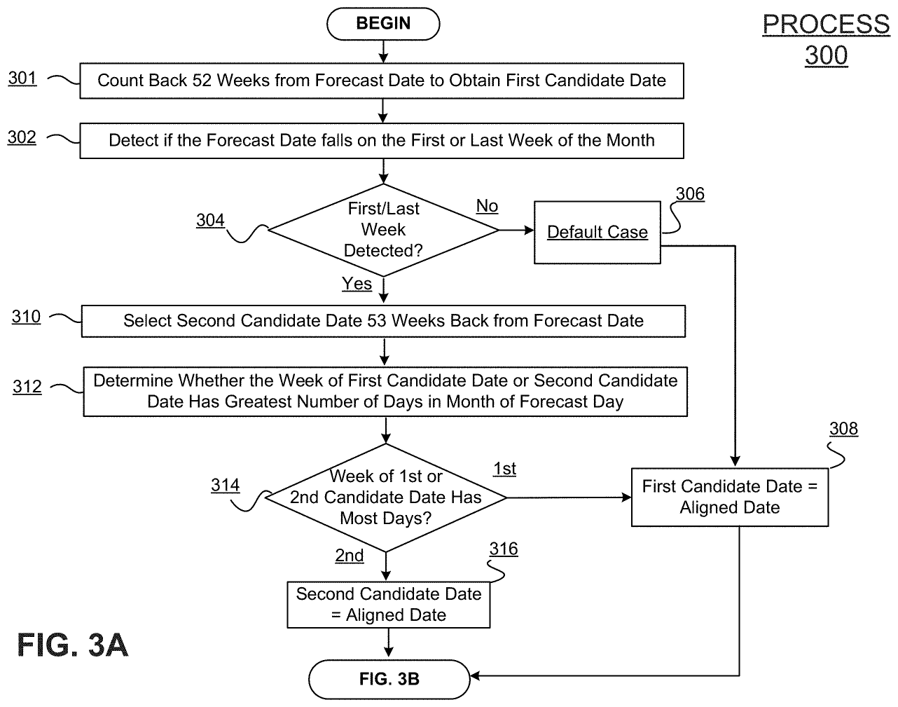

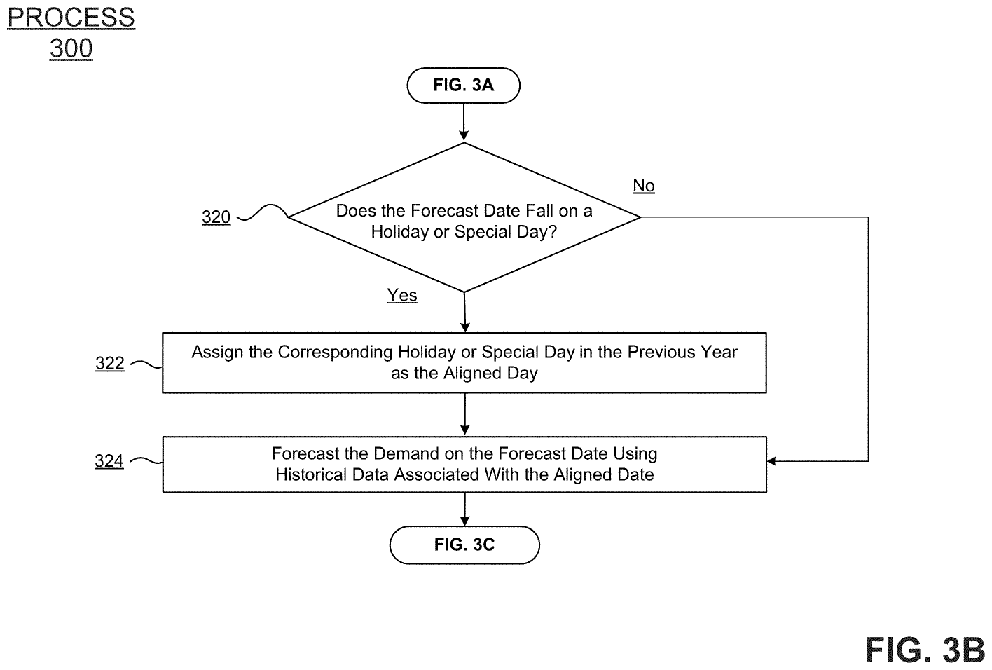

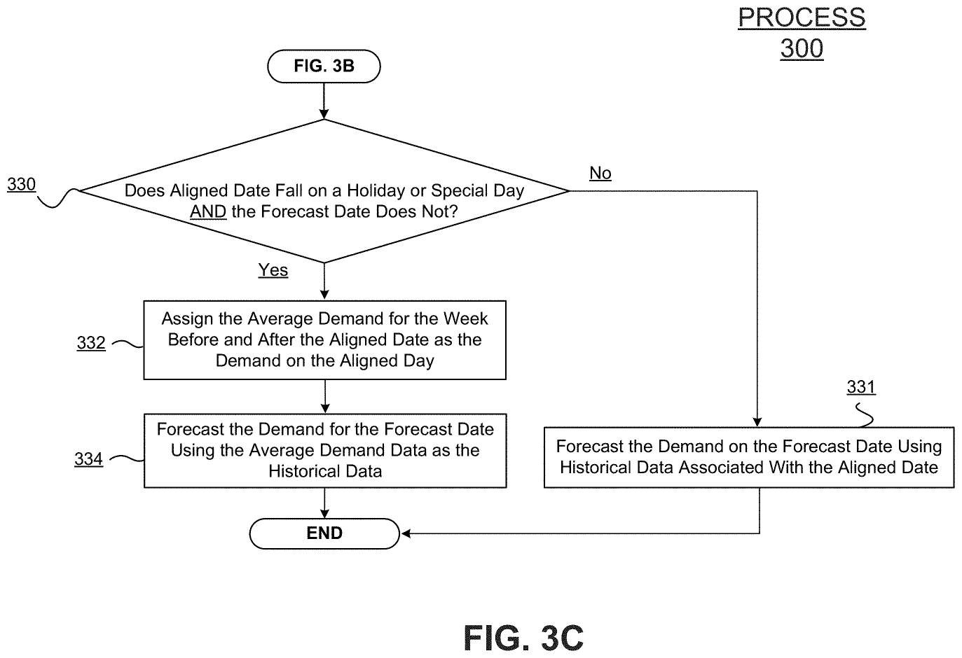

FIG. 3A depicts a flow chart of an example embodiment of a process for aligning days and weeks between years for forecast days falling in the first or last week of the month in accordance with the teachings of this disclosure. In one embodiment, process 300 may be performed using the date alignment appliance described previously in connection with FIGS. 1-2. Process 300 may be implemented in a machine-learning system that includes a computer hardware server comprising at least one processor and a network interface for communicating over one or more computer networks and physical storage including a memory and/or one or more data storage devices.

As a first operation the system may determine whether the forecast day falls on a normal day (i.e., not a holiday or special day). If the forecast day is not a holiday or special day, the system can be configured to count back 52 weeks to the anniversary date from the previous year and assign that date as the aligned date. In the illustrated embodiment, process 300 therefore begins at operation 301 by counting back 52 weeks from the forecast date to arrive at the first candidate date for the aligned date. The aligned date will be either the first candidate date or a second candidate date one week before.

Process 300 continues at decision operation block 302 whereby it is determined whether the forecast day falls on the first or last week of the month. In one embodiment, this determination can be made by accessing the calendar data supplied to the system. If the forecast day does not fall on the first or last week of the month, process 300 continues to the default case (operation 306) whereby the first candidate date is assigned as the aligned date in the previous year (operation 308) to be used for the forecasting analysis. Process 300 thereafter continues to the operations set forth in FIG. 3B below.

Otherwise, if the forecast date falls on the first or last week of the month, process 300 continues to operation 310 whereby a second candidate date one week before the first candidate date (or 53 weeks counted back from the forecast date) is selected for the analysis. In one aspect, the aligned date can be determined based on whether the calendar week (e.g., Monday through Sunday) in which the first candidate date falls or the calendar week in which the second candidate date falls includes the greatest number of days falling in the same month as that of the forecast date (operation 312). Process 300 continues to decision operation block 314. If the week in which the first candidate date falls includes the greatest number of days falling in the month, process 300 continues to operation 308 wherein the first candidate date is assigned as the aligned date, and if the week in which the second candidate date falls includes the greatest number of days falling in the month, process 300 continues to operation 316 wherein the second candidate date is assigned as the aligned date. Process 300 thereafter continues to the operations set forth in FIG. 3B in the illustrated embodiment.

Based on these determinations the system can select the most closely aligned date from the previous year for the purposes of providing more accurate demand forecasting for the forecast date. In a preferred embodiment, the results of this process may provide both the day that is most closely aligned by week of the year in the annual calendar and that is most closely aligned by where the day's associated week falls within the calendar month (i.e., first, last or middle week). The techniques described above may therefore be adapted to determine the most closely aligned date that is not only correctly positioned within the calendar year but also correctly positioned within the calendar month. The historical data from the most closely aligned date can substantially improve the accuracy of forecasts and forecasting algorithms because often it is the most relevant data and the best indicator of future demand.

In some industries, however, as the case may be, the middle-month weeks may be of more interest to a particular customer than the first or last week of the month. In other cases, a more customized combination of certain weeks within the month may be of particular interest to a user. The system is not intended to be limited to instances where the interesting cases fall only within the first or last week of the month, as embodiments can be configured in any manner desirable by a user/customer to identify when forecast days fall on one of the weeks of interest for the particular situation. In addition, the techniques described herein are not limited to only selecting the 52-week and 53-week candidate dates. The system can also be configured to select other candidate dates.

FIG. 3B depicts a flow chart of an example embodiment of a process for aligning days and weeks between years for forecast days falling on a holiday or special day in accordance with the teachings of this disclosure. If the day in question is a holiday or special day, the system can be configured to override the normal-day analysis to account for the holiday or special day. For example, if the day in question is Christmas Day, Dec. 25, 2018, then the most closely aligned date from the previous year should be set to Christmas Day, Dec. 25, 2019, regardless of the particular day of the week upon which Christmas Day fell in the previous year. Similarly, if the forecast day in question is an event date or other special date, such as for example the date of the Superbowl, then the aligned day should be set to whatever date the Superbowl was played in the previous year(s). For holidays and special days, the system can generate a table of holidays and special days as discussed above.

In the illustrated embodiment, process 300 continues at operation 320 whereby it is determined whether the forecast date falls on a holiday or special day. If not, process 300 continues to operation 324 wherein the demand forecast for the forecast date is determined using the historical data associated with the aligned date (i.e., the demand forecast for the forecast date is determined using normal-day processing including the operations set forth in FIG. 3A above). Process 300 thereafter continues to the operations set forth in FIG. 3C below. If, on the other hand, the forecast date falls on a holiday or special day (as determined for example based on the table of holidays and special days provided to the date alignment appliance), process 300 continues to operation 322 wherein the corresponding holiday or special day in the previous year is assigned as the aligned day for purposes of forecasting demand and the demand forecast for the forecast date is determined using the historical data associated with the aligned date (holiday or special day from previous year) at operation 324. Process 300 thereafter continues to the operations set forth in FIG. 3C below.

It should be noted that although in certain embodiments the holiday and/or special day determination is performed after the date alignment operations of FIG. 3A, in other embodiments, the holiday and/or special day determination may be performed before the date alignment operations of FIG. 3A.

The techniques described herein can also be adapted to account for circumstances where the forecast day falls on a normal day in the current calendar year but also corresponds with a holiday or special day in a previous year. FIG. 3C depicts a flow chart of an example embodiment of a process for aligning days and weeks between years for normal forecast days corresponding with a date falling on a holiday or special day in a previous year in accordance with the teachings of this disclosure. This type of situation can happen in cases where the holiday or special day is a moving holiday or special day that falls on different days of the week from year to year. In such cases, the day from the previous year that falls on a holiday or special day will likely not be a good indicator of the demand on the normal forecast day in the current calendar year, and thus the results for the demand forecast could become significantly skewed.

An example of such a situation would be where the day in question is a normal Thursday and the aligned day 52 weeks previously falls on Thanksgiving Day. In one embodiment, the system can be adapted to take the average of the demand forecasts for the dates a week before and a week after Thanksgiving Day in the previous year and assign that average demand as the demand value for the forecasting operations. In that case the system can be configured to recognize the occurrence of this situation and select a different day for the alignment or provide a modified demand forecast.

In one embodiment, the modified demand forecast can be obtained by taking the average of the demand from the week before and after the holiday or special day in the previous year and using that value as the demand for the forecast date. In another embodiment, the modified demand can be adapted to shift the aligned date by plus or minus one week in the previous year and to use that demand data directly for the demand forecast on the forecast day. In yet other embodiments, the modified demand can be obtained based on user preferences and customized configuration. In other cases, system can be configured to determine whether the weeks before and after the holiday or special day in the previous year fall on the first or last week of the month, and if so, to select the day in the week from the previous year that has the greatest number of days in the same month as the forecast day in accordance with the techniques described above.

In the illustrated embodiment of FIG. 3C, process 300 continues to decision operation block 330 whereby it is determined whether the aligned date from a previous year falls on a holiday or special day and the forecast day does not fall on a holiday or special day in the calendar year. If not, the system defaults back to normal day processing and process 300 continues to operation 331 wherein the demand is forecast on the forecast date using the historical demand data associated with the aligned date determined in the operations set forth in FIG. 3A or 3B.

But if the aligned date from the operations set forth in FIGS. 3A and/or 3B does indeed fall on a holiday or special day and the forecast day falls on a normal day, in the illustrated embodiment process 300 continues to operation 332 wherein the average demand for the weeks before and after the aligned date can be assigned as the demand on the aligned day. That is, in the illustrated embodiment the modified demand forecast can be obtained by taking the average of the demand from the weeks before and after the holiday or special day in the previous year. Process 300 continues to operation 334 wherein the demand can be forecasted for the forecast date using the average demand data from operation 332 as the historical data.

As discussed above, in an alternate embodiment the modified demand can be adapted to shift the aligned day by plus or minus one week in the previous year and to use that demand data directly in the forecasting analysis for the forecast day. In yet other embodiments, the modified demand can be obtained based on user preferences and/or customized configurations for a particular customer's unique circumstances. This completes process 300 according to one example embodiment.

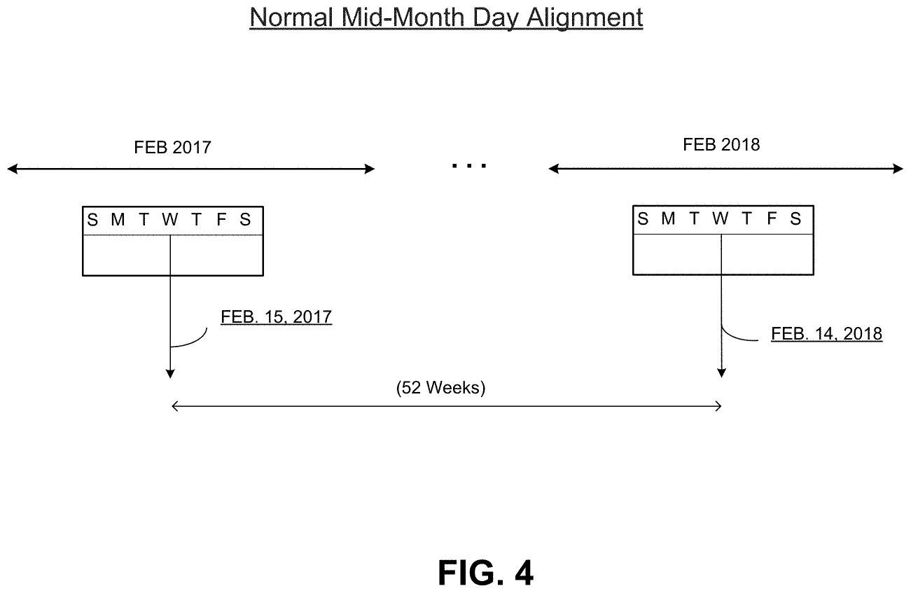

Some practical examples are shown in FIGS. 4-6 which depict timing diagram showing examples of the date alignment process in accordance with the teachings of this disclosure. FIG. 4 illustrates the default alignment processing for the normal, mid-month weeks whereby the aligned date is determined based on counting back 52 weeks from the forecast date. As shown, the date 52 weeks before Wednesday, Feb. 14, 2018 corresponds with Wednesday, February 15 in the previous year (2017).

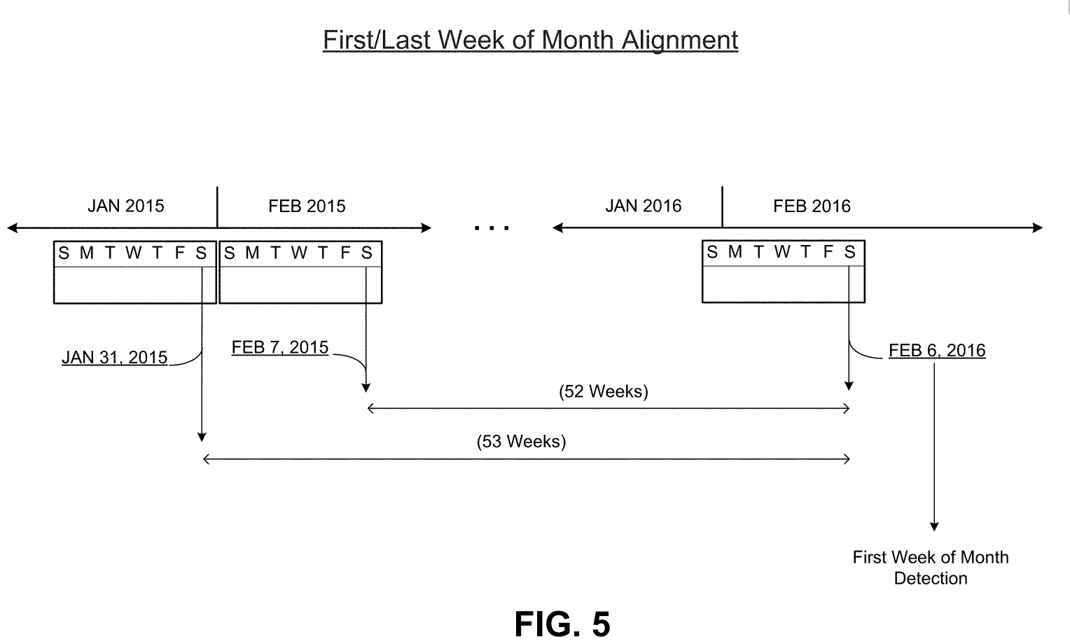

FIG. 5 illustrates an example of the alignment processing for forecast days falling on the first or last week of the month as described with respect to the operations set forth in FIG. 3A. In this example, the system can be configured to detect that the forecast day, Saturday, Feb. 6, 2016 falls on the first week of month based on comparing the dates with the calendar data input to the system. The system can thereafter determine whether the 52-week candidate date, Saturday Feb. 7, 2015 or the 53-week candidate date, Saturday, Jan. 31, 2015, includes the greatest number of days in the month corresponding to the forecast day. In this case, the forecast day falls in the month of February and the first candidate date, Saturday, Feb. 7, 2015 falls in a week having the greater number of days in February. Accordingly, in this embodiment, the system can determine that Feb. 7, 2015 should be assigned as the most closely aligned day in 2015 that corresponds to the forecast day, Saturday Feb. 6, 2016. The value of the demand on the aligned date can be used as an input to the data forecast modeling and analysis.

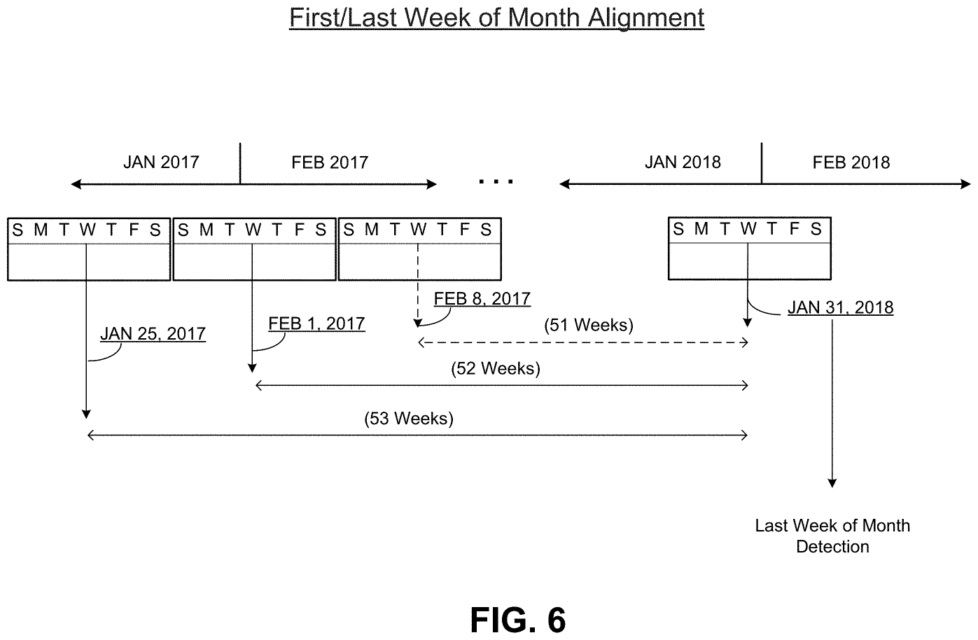

FIG. 6 illustrates another example of the alignment processing for forecast days falling on the first or last week of the month as described with respect to the operations set forth in FIG. 3A. In this example, the 53-week candidate date Wednesday, Jan. 25, 2017 falls in the week having the greatest number of days falling in the calendar month (January) corresponding with the forecast date Wednesday, Jan. 31, 2018. As discussed above, a third candidate date may also be selected, in this case, Wednesday, Feb. 8, 2018 in at least certain embodiments.

### Example Hardware Implementation

Embodiments of the present disclosure may be practiced using various computer systems including hand-held devices, microprocessor systems, programmable electronics, laptops, tablets and the like. The embodiments can also be practiced in distributed computing environments where tasks are performed by remote processing devices that are linked through one or more wire-based or wireless networks. A hardware module may be implemented mechanically, electronically, or any suitable combination thereof. A hardware module may include dedicated circuitry or logic that is permanently configured to perform certain operations. For example, a hardware module may be a special-purpose processor, such as a Field Programmable Gate Array (“FPGA”) or an Application Specific Integrated Circuit (“ASIC”), Programmable Logic Device (“PLD”), etc.

A hardware module may also include programmable logic or circuitry that is temporarily configured by software to perform operations. For example, a hardware module may include software executed by a general-purpose processor or other programmable processor. Once configured by such software, hardware modules may become specific machines (or specific components of a machine) tailored to perform one or more configured functions. It will be appreciated that the decision to implement a hardware module mechanically in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain of the operations described in this disclosure.

Similarly, the functions described in this disclosure may be at least partially processor-implemented, with a particular processor or processors being an example of hardware. For example, at least some of the operations of a function may be performed by one or more processors or processor-implemented modules. Moreover, the one or more processors may also operate to support performance of the relevant operations in a cloud computing environment or as software as a service (“SaaS”). In addition, at least some of the operations may be performed by a group of computers (as examples of machines including processors), with these operations being accessible via a network (e.g., the Internet) and via one or more appropriate interfaces (e.g., an API).

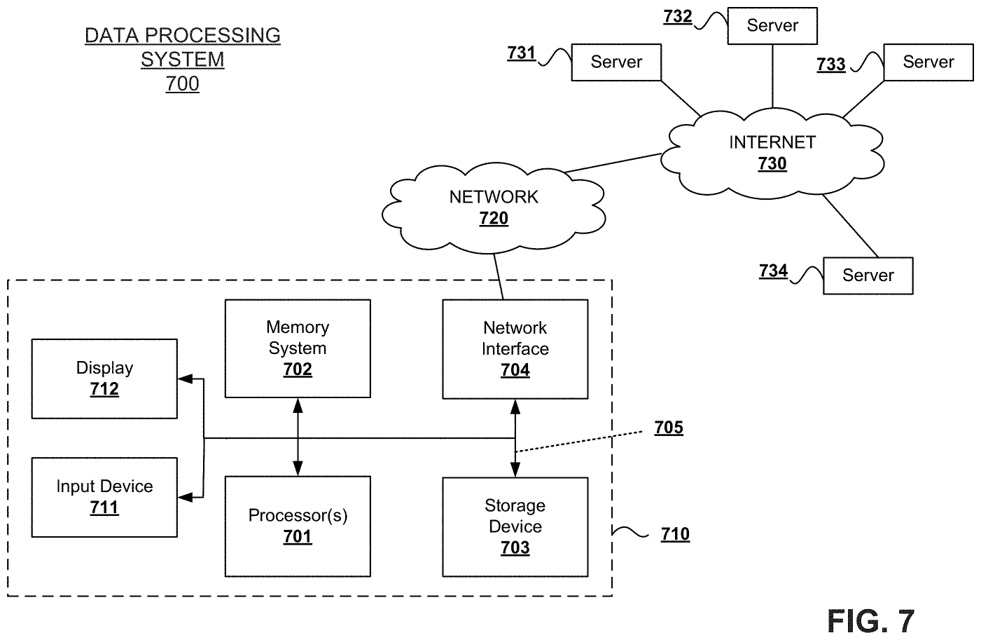

FIG. 7 depicts an overview block diagram of an example data processing system upon which the embodiments described in this disclosure may be implemented. It is to be understood that a variety of computers configurations may be used to implement the described techniques. While FIG. 7 illustrates various components of a data processing system 700, it is not intended to represent any particular architecture or manner of interconnecting components. It will also be appreciated that network computers and other data processing systems, which have fewer components or additional components, may be used. The data processing system 700 may, for example, comprise a personal computer (PC), workstation, laptop computer, tablet, smartphone or other hand-held wireless device, or any device having similar functionality.

In the illustrated embodiment, data processing system 700 includes a computer system 710. Computer system 710 includes an interconnect bus 705 (or other communication mechanism for communicating information) and one or more processor(s) 701 coupled with the interconnect bus 705 for processing information. Computer system 710 also includes a memory system 702 coupled with the one or more processors 701 via the interconnect bus 705. Memory system 702 is configured to store information and instructions to be executed by processor 701, including information and instructions for performing the techniques described above. This memory system may also be used for storing programs executed by processor(s) 701. Possible implementations of this memory system may be, but are not limited to, random access memory (RAM), read only memory (ROM), or combination thereof.

In the illustrated embodiment, a storage device 703 is also provided for storing information and instructions. Typically storage device 703 comprises nonvolatile memory. Common forms of storage devices include, for example, a hard drive, a magnetic disk, an optical disk, a CD-ROM, a DVD, a flash or other non-volatile memory, a USB memory card, or any other computer-readable medium from which a computer can read data and instructions. Storage device 703 may store source code, binary code, or software files for performing the techniques above. In addition, while FIG. 7 shows that storage device 703 as a local device connected with the components of the data processing system, it will be appreciated by skilled artisans that the described techniques may use a storage device remote from the system, such as a database or other network storage device coupled with the computer system 710 through a network interface such as network interface 704.

Network interface 704 may provide communications between computer system 710 and a network 720. The network interface 704 may be a wireless or wired connection, or any combination thereof. Computer system 710 is configured to send and receive information through the network interface 704 across one or more networks 720 such as a local area network (LAN), wide-area network (WAN), wireless or Bluetooth network, or the Internet 730, etc. Computer system 710 may access data and features on systems residing on one or multiple different hardware servers 731-734 across the network 720. Hardware servers 731-734 and associated server software may also reside in a cloud-computing environment.

Storage device and memory system are both examples of non-transitory computer readable storage media. Embodiments in this disclosure can be embodied in computer-readable code stored on any computer-readable medium, which when executed by a computer or other data processing system, can be adapted to cause the system to perform operations according to the techniques described in this disclosure. Computer-readable media may include any mechanism that stores information in a form accessible by a data processing system such as a computer, network device, tablet, smartphone, or any device having similar functionality. Examples of computer-readable media include any type of non-transitory, tangible media capable of storing information thereon, including floppy disks, hard drive disks (“HDDs”), solid-state devices (“SSDs”) or other flash memory, optical disks, digital video disks (“DVDs”), CD-ROMs, magnetic-optical disks, ROMs, RAMs, erasable programmable read only memory (“EPROMs”), electrically erasable programmable read only memory (“EEPROMs”), magnetic or optical cards, or any other type of media suitable for storing data and instructions in an electronic format. Computer-readable media can also be distributed over a network-coupled computer system stored and executed in a distributed fashion. Storage device 703 and memory system 702 are both examples of non-transitory computer readable storage media.

Further, computer system 710 may be coupled via interconnect bus 705 to a display 712 for displaying information to a computer user. An input device 711 such as a keyboard, touchscreen, and/or mouse is coupled to bus 705 for communicating information and command selections from the user to processor 701. The combination of these components allows the user to communicate with the system. In some systems, bus 705 represents multiple specialized interconnect buses.

With these embodiments in mind, it will be apparent from this description that aspects of the described techniques may be embodied, at least in part, in software, hardware, firmware, or any combination thereof. It should also be understood that embodiments can employ various computer-implemented functions involving data stored in a computer system. The techniques may be carried out in a computer system or other data processing system in response executing sequences of instructions stored in memory.

This disclosure has been described in terms of the representative embodiments disclosed herein. The above example embodiments should not be deemed to be the only embodiments and are presented to illustrate the flexibility and advantages of the described techniques. Other embodiments, implementations, and/or equivalents will be evident to those skilled in the art and may be employed without departing from the spirit and scope of this disclosure as defined by the following claims.

What is claimed is:

1. A method for aligning days and weeks between years for demand forecasting, the method comprising:
at a machine learning system implemented in a computer hardware server comprising a processor, system memory and a network interface for communicating with a database over a computer network via a database server, the database comprising one or more data storage devices adapted for storing demand data routed over the computer network from one or more data sources, the machine learning system configured with one or more machine learning models for forecasting demand on a forecast date:
receiving, by the machine learning system, a signal representing the forecast date and calendar data;
identifying, by the machine learning system, a first candidate date in a first week one year before the forecast date and a second candidate date in a second week, the first and second candidate dates to be assigned as an aligned date from a previous year for forecasting demand on the forecast date;
determining, based on accessing the data structure of holidays and special days, whether the forecast date falls on the first or last week of the month, and performing the following operations when the forecast date falls on the first or last week of the month:
(i) determining which of a first week or the second week has the greatest number of days in the month of the forecast date;
(ii) assigning the first candidate date as the aligned date when the first week has the greatest number of days in the month; and
(iii) assigning the second candidate date as the aligned date when the second week has the greatest number of days in the month; and
retrieving demand data associated with the aligned date from the database; and
computing a demand forecast for the forecast date based on processing the retrieved demand data using the one or more of the machine learning models.

2. The method of claim 1 further comprising assigning the first candidate date as the aligned date for forecasting demand on the forecast date in a default case when the forecast date does not fall on the first or last week of the month.

3. The method of claim 1 wherein a date 53 weeks before the forecast date is selected as the second candidate date for the aligned date.

4. The method of claim 1 further comprising:
analyzing the calendar data and generating a data structure of holidays and special days based on the calendar data;
determining, based on accessing the data structure of holidays and special days, whether the forecast date falls on a holiday or special day; and
assigning the holiday or special day in the previous year as the aligned date for forecasting demand on the forecast date when the forecast date falls on a holiday or special day.

5. The method of claim 1 further comprising:
analyzing the calendar data and generating a data structure of holidays and special days based on the calendar data;
determining, based on accessing the data structure of holidays and special days, whether the first candidate date falls on holiday or special day but the forecast date does not fall on a holiday or special day;
computing an average value for the demand forecast on the first and second candidate days; and
using the average value of the demand forecast on the first and second candidate days as the demand value for the forecast date.

6. The method of claim 1 wherein a separate demand forecast is computed for each good, product and/or service using a separate machine learning model.

7. The method of claim 1 further comprising;
receiving external factors in addition to the demand data as inputs to the machine learning system; and
computing the demand forecast based at least in part on the external factors.

8. A system for aligning days and weeks between years for demand forecasting, the system comprising:
a machine learning system implemented in a computer hardware server comprising a processor, system memory and a network interface for communicating over a computer network, the machine learning system configured with one or more machine learning models for forecasting demand on a forecast date;
a database comprising a database server and one or more data storage devices adapted for storing demand data routed over the computer network from one or more data sources, the database server in communication with the computer hardware server via the computer network, the demand data stored in the database and categorized by date into one or more datasets, wherein the computer hardware server is configured to:
receive, by the machine learning system, a signal representing the forecast date and calendar data;
identify, by the machine learning system, a first candidate date in a first week one year before the forecast date and a second candidate date in a second week, the first and second candidate dates to be assigned as an aligned date from a previous year for forecasting demand on the forecast date;
determine, based on accessing the data structure of holidays and special days, whether the forecast date falls on the first or last week of the month, and to perform the following operations when the forecast date falls on the first or last week of the month:
(i) determine which of a first week or the second week has the greatest number of days in the month of the forecast date;
(ii) assign the first candidate date as the aligned date when the first week has the greatest number of days in the month; and
(iii) assign the second candidate date as the aligned date when the second week has the greatest number of days in the month; and
retrieve demand data associated with the aligned date from the database; and
calculate a demand forecast for the forecast date based on processing the retrieved demand data using the one or more of the machine learning models.

9. The system of claim 8 wherein the computer hardware server is further configured to assign the first candidate date as the aligned date for forecasting demand on the forecast date in a default case when the forecast date does not fall on the first or last week of the month.

10. The system of claim 8 wherein a date 53 weeks before the forecast date is selected as the second candidate date for the aligned date.

11. The system of claim 8 wherein the computer hardware server is further configured to:
analyze the calendar data and generate a data structure of holidays and special days based on the calendar data;
determine, based on accessing the data structure of holidays and special days, whether the forecast date falls on a holiday or special day; and
assign the holiday or special day in the previous year as the aligned date for forecasting demand on the forecast date when the forecast date falls on a holiday or special day.

12. The system of claim 8 wherein the computer hardware server is further configured to:
analyze the calendar data and generate a data structure of holidays and special days based on the calendar data;
determine, based on accessing the data structure of holidays and special days, whether the first candidate date falls on holiday or special day but the forecast date does not fall on a holiday or special day;
calculate an average value for the demand forecast on the first and second candidate days; and
use the average value of the demand forecast on the first and second candidate days as the demand value for the forecast date.

13. The system of claim 8 wherein the computer hardware server is further configured to:
receive external factors in addition to the demand data as inputs to the machine learning system; and
calculate the demand forecast based at least in part on the external factors.

14. A nontransitory computer readable storage medium adapted for storing programmed computer code executable by a computer hardware server for performing operations, the computer hardware server implementing a machine learning system configured with one or more machine learning models for forecasting demand on a forecast date, the operations comprising:
receiving, by the machine learning system, a signal representing the forecast date and calendar data;
identifying, by the machine learning system, a first candidate date in a first week one year before the forecast date and a second candidate date in a second week, the first and second candidate dates to be assigned as an aligned date from a previous year for forecasting demand on the forecast date;
determining, based on accessing the data structure of holidays and special days, whether the forecast date falls on the first or last week of the month, and performing the following operations when the forecast date falls on the first or last week of the month:
(i) determining which of a first week or the second week has the greatest number of days in the month of the forecast date;
(ii) assigning the first candidate date as the aligned date when the first week has the greatest number of days in the month; and
(iii) assigning the second candidate date as the aligned date when the second week has the greatest number of days in the month; and
retrieving demand data associated with the aligned date from the database; and
computing a demand forecast for the forecast date based on processing the retrieved demand data using the one or more of the machine learning models.

15. The nontransitory computer readable storage medium of claim 14 wherein the operations further comprise assigning the first candidate date as the aligned date for forecasting demand on the forecast date in a default case when the forecast date does not fall on the first or last week of the month.

16. The nontransitory computer readable storage medium of claim 14 wherein the operations further comprise selecting a date 53 weeks before the forecast date as the second candidate date for the aligned date.

17. The nontransitory computer readable storage medium of claim 14 wherein the operations further comprise:
analyzing the calendar data and generating a data structure of holidays and special days based on the calendar data;
determining, based on accessing the data structure of holidays and special days, whether the forecast date falls on a holiday or special day; and
assigning the holiday or special day in the previous year as the aligned date for forecasting demand on the forecast date when the forecast date falls on a holiday or special day.

18. The nontransitory computer readable storage medium of claim 14 wherein the operations further comprise:
analyzing the calendar data and generating a data structure of holidays and special days based on the calendar data;
determining, based on accessing the data structure of holidays and special days, whether the first candidate date falls on holiday or special day but the forecast date does not fall on a holiday or special day;
computing an average value for the demand forecast on the first and second candidate days; and
using the average value of the demand forecast on the first and second candidate days as the demand value for the forecast date.

19. The nontransitory computer readable storage medium of claim 14 wherein a separate demand forecast is computed for each good, product and/or service using a separate machine learning model.

20. The nontransitory computer readable storage medium of claim 14 wherein the operations further comprise:
receiving external factors in addition to the demand data as inputs to the machine learning system; and
computing the demand forecast based at least in part on the external factors.
